(19) United States
(12) Patent Application Publication
(10) Pub. No.: US 2017/0295617 A1
(43) Pub. Date: Oct. 12, 2017

(54) LIGHT-EMITTING DIODE (LED) DRIVING DEVICE AND LED LIGHTING DEVICE CONTAINING THE SAME

(71) Applicant: SENGLED CO., LTD., Shanghai (CN)

(72) Inventors: Yehua WAN, Shanghai (CN); Jinxiang SHEN, Shanghai (CN)

(21) Appl. No.: 15/325,635

(22) PCT Filed: Jul. 21, 2016
(86) PCT No.: PCT/CN2016/090797

§ 371 Date: Jan. 11, 2017

(30) Foreign Application Priority Data
Sep. 30, 2015 (CN) 201510640548.7

(51) Int. Cl. H05B 33/08; H05B 37/02

(52) U.S. Cl. CPC H05B 33/0815; H05B 37/02; H05B 33/0812; H05B 37/0263

(57) ABSTRACT

The present disclosure provides a light-emitting diode (LED) driving device, including a control unit and a power unit integrated on a packaging substrate to form an integrated circuit (IC). The control unit is electrically connected to the power unit for controlling the power unit to convert an AC current to a DC current for an LED load to emit light. The control unit is configured to generate a control signal with a lowest working frequency higher than 250 KHz.

### CROSS-REFERENCES TO RELATED APPLICATIONS

This application claims the priority of Chinese Patent Application No. 201510640548,7 filed on Sep. 30, 2015, the entire content of which is incorporated herein by reference.

### FIELD OF THE DISCLOSURE

The present disclosure relates to the field of light emitting diode (LED) technologies and, more particularly, relates to a light-emitting diode (LED) driving device and an LED lighting device containing the LED driving device.

### BACKGROUND

Conventional LED driving devices used for alternating current-direct current (AC-DC, with an input range of 90-264 V_{AC}) conversion are often high-voltage silicon metal oxide semiconductor field effect transistors (MOSFETs). The high-voltage silicon MOSFETs often have issues such as high parasitic parameters, high on-resistance, high interference, and slow switching speed. As a result, the operation of the LED driving devices often has low efficiency.

The disclosed devices are directed to solve one or more problems set forth above and other problems.

### BRIEF SUMMARY OF THE DISCLOSURE

One aspect or embodiment of the present disclosure provides a light-emitting diode (LED) driving device. The driving device includes a control unit and a power unit integrated on a packaging substrate to form an integrated circuit (IC). The control unit is electrically connected to the power unit for controlling the power unit to convert an AC current to a DC current for an LED load to emit light. The control unit is configured to generate a control signal with a lowest working frequency higher than 250 KHz.

Further, the power unit includes a GaN metal oxide semiconductor field effect transistor (MOSFET) wafer.

Further, the LED driving device includes a packaging substrate. The control unit and the power unit are fixed on the packaging substrate. Electrical contact points of the control unit and the power unit for connecting external components are each connected to a pin of the packaging substrate. A bonding material is used to package the control unit and the power unit on the packaging substrate.

Further, the electrical contact points include a gate electrode, a source electrode, and a drain electrode of the power unit. The gate electrode of the power unit is connected to an output terminal of the control unit, the source electrode of the power unit is grounded, and the drain electrode of the power unit is connected to the anodes of the LED loads.

Further, the LED driving device is incorporated in one or more of a step-down BUCK-chopper circuit, bidirectional BUCK BOOST-chopper circuit, a step-up BOOST-chopper circuit, a flyback converter circuit, a SEPIC circuit, a FORWARD circuit, and a HALFBRIDGE circuit.

Another aspect or embodiment of the present disclosure provides a light-emitting diode (LED) lighting device. The LED lighting device includes a power supply circuit, a driving circuit, and at least one LED. The power supply circuit is connected to an input terminal of the driving circuit. An output terminal of the driving circuit is connected to the at least one LED. The driving circuit includes at least one LED driving device as described above.

### BRIEF DESCRIPTION OF THE DRAWINGS

The following drawings are merely examples for illustrative purposes according to various disclosed embodiments and are not intended to limit the scope of the present disclosure.

FIG. 1 illustrates an exemplary LED driving device consistent with various embodiments of the present disclosure;

FIG. 2 illustrates an exemplary circuit containing the disclosed LED driving device consistent with various disclosed embodiments of the present disclosure;

FIG. 3 illustrates another exemplary circuit containing the disclosed LED driving device consistent with various disclosed embodiments of the present disclosure;

FIG. 4 illustrates another exemplary circuit containing the disclosed. LED driving device consistent with various disclosed embodiments of the present disclosure;

FIG. 5 illustrates another exemplary circuit containing the disclosed LED driving device consistent with various disclosed embodiments of the present disclosure;

FIG. 6 illustrates an exemplary circuit containing the disclosed LED driving device consistent with various disclosed embodiments of the present disclosure;

FIG. 7 illustrates the block diagram of an exemplary LED lighting device consistent with various disclosed embodiments of the present disclosure; and

FIG. 8 illustrates the block diagram of an exemplary control unit used in various disclosed embodiments of the present disclosure.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

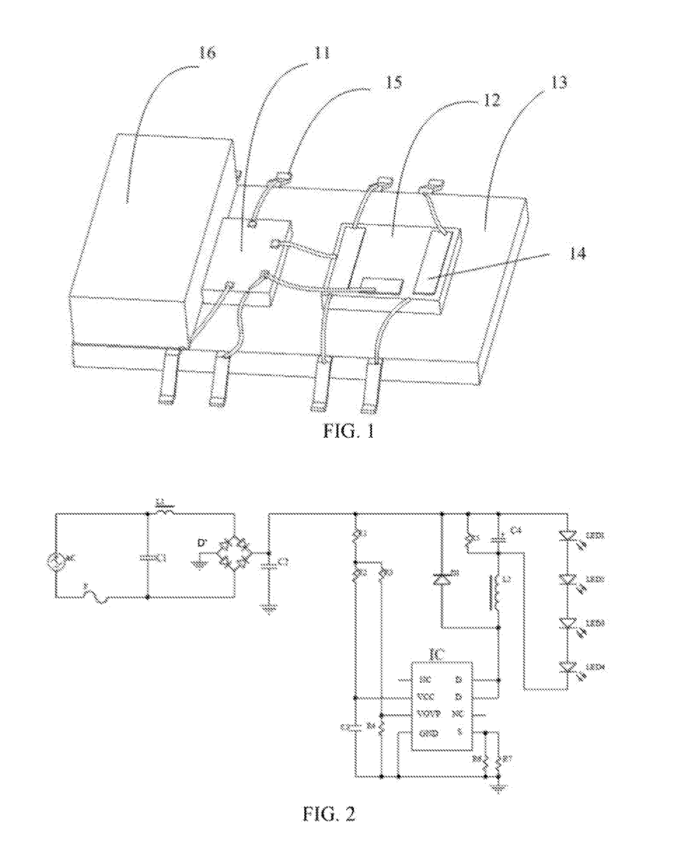

FIG. 1 illustrates an exemplary LED driving device. As shown in FIG. 1, the LED driving device may include a control unit 11 and a power unit 12. The control unit 11 and the power unit 12 may be electrically connected. The power unit 12 may be a GaN MOSFET wafer, i.e., a wafer carrying a GaN MOSFET. The control unit II may be configured to generate control signals with the lowest working frequency higher than 250 K Hz. The control unit 11 may control the power unit 12 to convert inputted AC current to DC current, to drive the LEDs.

In one embodiment, the LED driving device may further include a packaging substrate or a wafer holder/stage 13. The packaging substrate 13 may have similar functions to a wafer holder. One of a packaging substrate or a wafer holder may be used to provide support to the control unit 11, the power unit 12, and other related parts according to different applications and designs. In the present disclosure, for illustrative purposes, a packaging substrate 13 is used for describing the embodiments. The control unit 11 and the power unit 12 may be fixed on the packaging substrate 13. The electrical contact points, of the control unit 11 and the power unit 12, that have connection with external components may each be connected to a pin 15 of the packaging substrate 13. A packaging material 16 may be used to package the control unit 11 and the power unit 12 on the packaging substrate 13.

Referring to FIG. 1, the structure of an exemplary LED driving device is shown. The LED driving device includes the integrated circuit (IC) shown FIG. 1. The LED driving device may be configured to convert power, i.e., convert AC current to DC current for the operation of the LEDs. The control unit 11 of the LED driving device may generate switching control signals with the lowest working frequency higher than 250 KHz. The power unit 12 may include a GaN MOSFET wafer. The control unit 11 and power unit 12 may be fixed on the packaging substrate 13 with pins. The electrical contact points 14 of the control unit 11 and the power unit 12 may be electrically connected to the pins on the packaging substrate 13 through conductive wires such as gold wires, copper wires, tin wires, aluminum wires, etc. The packaging material 16 may be used to package the components and parts to an IC with desired dimensions. In some embodiments, the packaging material 16 may be resin.

The electrical contact points may include the connecting points of the control unit 11 and the three electrodes of the power unit 12. The three electrodes of the power unit 12 may include a gate electrode, a source electrode, and a drain electrode, of the power unit 12 or the GaN MOSFET. The gate electrode of the power unit 12 may be connected to the output terminal of the control unit 11, where the output terminal is configured to output control signals. The source electrode of the power unit 12 may be grounded. The drain electrode of the power unit 12 may be connected to the anodes of the LEDs for driving the LEDs. The control unit 11 may be input a driving signal to the gate electrode of the power unit 12. Meanwhile, the control unit 11 may detect feedback signals from external environment to control the frequency and the duty cycle of the driving signal. The source electrode and the drain electrode may be connected to the packaging substrate 13 through the conductive wires for converting power.

The disclosed LED driving device may include a power unit and a control unit. The power unit may include a GaN MOSFET wafer. Controlled by the control unit, the power unit may convert the inputted AC current to DC current that is suitable for the operation of the LEDs. In one embodiment, the power unit may include a GaN MOSFET wafer. By using the GaN MOSFET wafer, as the power unit, when operating at a high frequency, the power unit may have less, interference, lower wear and tear, and higher switching speed. The operation efficiency of the LED driving device may be improved.

FIGS. 2-6 each illustrates an application of the LED driving device used in an exemplary circuit. The LED driving device is shown as the IC in each of FIGS. 2-6.

FIG. 2 illustrates a step-down BUCK-chopper circuit incorporating the disclosed LED driving device. As shown in FIG. 2, the LED driving device may be incorporated in the step-down BUCK-chopper circuit. The step-down BUCK-chopper circuit may include a power supply circuit, a chopper circuit, and an LED load. The power supply circuit may include an AC power supply, a fuse F, capacitors C1 and C2, inductance L1, and a bridge rectifier D*. The chopper circuit may include resistors R1, R2, R3, R4, R5, R6, and R7, capacitors C3 and C4, inductance L2, diode D1, and the LED driving device. The LED load may include a plurality of LEDs, e.g., LED1-LED4 as shown in FIG. 2. In FIGS. 2-5 of the present disclosure, S represents source electrode of the GaN MOSFET in the LED driving device, and D represents drain electrode of the GaN MOSFET in the LED driving device. NC represents a “not connected” pin. VCC represents the IC power supply pin GND represents the ground pin VOVP represents VCC over voltage protection pin. The connections of the pins are known to those skilled in the art and is not repeated herein.

Because the working principles of the disclosed LED driving device or IC is the same when used in an exemplary circuit in this disclosure, for illustrative purposes, the working principles of the LED driving device may be described in detail using the step-down BUCK-chopper circuit shown in FIG. 2. As shown in FIG. 2, a AC current may flow through the fuse F, the inductance L1, and the bridge rectifier D′, and may enter the chopper circuit as a rectified AC voltage. The rectified AC voltage may be filtered by capacitor C2. The resistors R1 and R2 may divide the filtered AC voltage based on their resistances to obtain a lower AC voltage. The lower AC voltage may be applied on the VCC pin of the LED driving, device or IC. When the applied lower AC voltage reaches the turn-on voltage of the LED driving device, the LED driving device may be turned on or may start functioning. The S and D of the power unit 12 in the LED driving device may become electrically connected to each other. At this time, electric current may flow through the inductance L2, the LED load LED1-LED4, the power unit 12 in the LED driving device, and resistors R6 and R7. The electric current may increase according to a certain pattern, e.g., a slope. That is, the current flowing through the resistors R6 and R7 may also increase according to the same pattern. The current flowing through the resistors R6 and R7 may form a voltage or a detecting voltage. When the current increases to a certain value, the detecting voltage formed on the resistors R6 and R7 may reach a threshold detecting voltage of the LED driving device, and the LED driving device may turn off the power unit 12. The S and D of the power unit of the LED driving device may be turned off or disconnected so that the current flowing through the inductance L1 would not continue to increase.

According to Faraday's law of electromagnetic induction, a counter-electromotive force may be generated in the inductance L1. At this time, the inductance L1 may release electromagnetic energy through diode D1 and LED1-LED4, and a loop current may be formed. The loop current may decrease according to a certain pattern, e.g., a slope. When the LED driving device detects the loop current decreases to approximately zero, the LED driving device may turn on the power unit 12 again, and the S and D of the power unit 12 may be electrically connected again. The step-down BUCK-chopper circuit may repeat the operation described above so that continuous current may flow through LED1-LED4. The LED load, i.e., LED1-LED4, may emit light continuously.

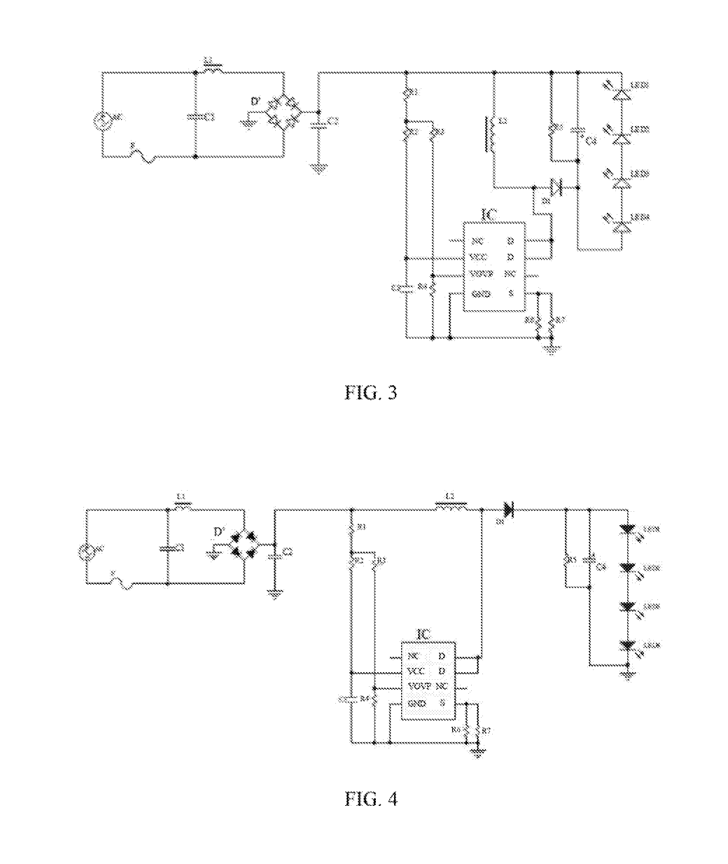

FIG. 3 illustrates a bidirectional BUCK BOOST-chopper circuit. As shown in FIG. 3, the LED driving device may be incorporated in the bidirectional BUCK BOOST-chopper circuit for implementing bidirectional current conversion between the power supply circuit and the LED load. Similar to FIG. 2, the bidirectional BUCK BOOST-chopper circuit may include a power supply circuit, a chopper circuit, and an LED load. The power supply circuit may include an AC power supply, a fuse F, capacitors C1 and C2, inductance L1, and a bridge rectifier D′. The chopper circuit may include resistors R1, R2, R3. R4, R5, R6, and R7, capacitors C3 and C4, inductance L2, diode D1, and the LED driving device. The LED load may include a plurality of LEDs, e.g., LED1-LED4 as shown in FIG. 3.

FIG. 4 illustrates a step-up BOOST-chopper circuit. As shown in FIG, 4, the LED driving device may be incorporated in the step-up BUCK BOOST-chopper circuit. Similar to FIG. 2, the step-up BOOST-chopper circuit may include a power supply circuit, a chopper circuit, and an LED load. The power supply circuit may include an AC power supply, a fuse F, capacitors C1 and C2, inductance L1, and a bridge rectifier D′. The chopper circuit may include resistors R1, R2, R3, R4, R5, R6, and R7, capacitors C3 and C4, inductance L2, diode D1, and the LED driving device, The LED load may include a plurality of LEDs, e.g., LED1-LED4 as shown in FIG. 4.

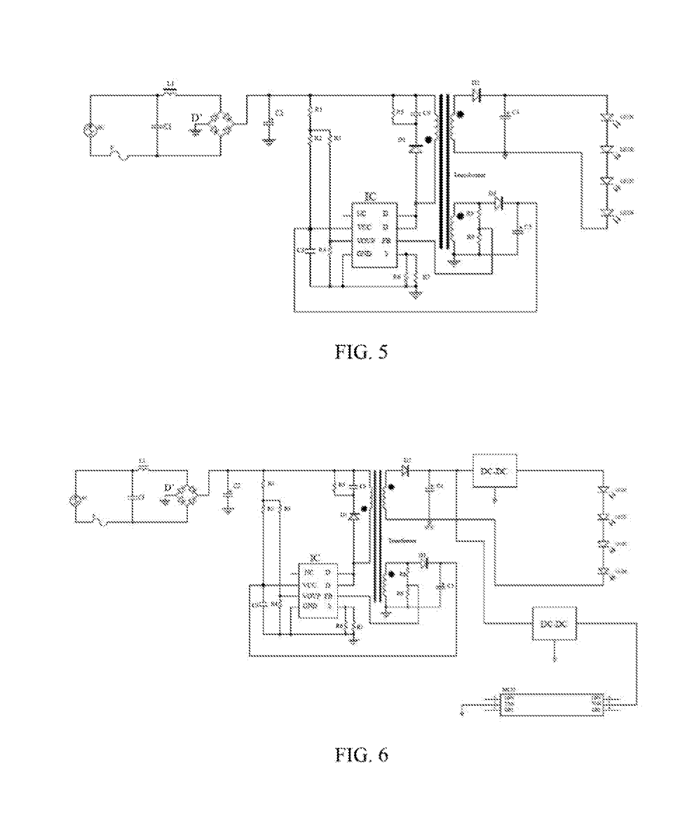

FIG. 5 illustrates a flyback converter circuit for AC-DC conversion. As shown in FIG. 5, the LED driving device may be incorporated in the flyback converter circuit. Similar to FIG. 2, the flyback converter circuit may include a power supply circuit, a chopper circuit, and an LED load. The power supply circuit may include an AC power supply, a fuse F, capacitors C1 and C2, inductance L1, and a bridge rectifier D′. The chopper circuit may include resistors R1, R2. R3, R4, RS, R6, R7, R8, and R9, capacitors C3, C4, C5, and C9, a transformer, diode D1, and the LED driving device. The LED load may include a plurality of LEDs, e.g., LED1-LED4 as shown in FIG. 5. In FIGS. 5 and 6, FB represents the feedback pin.

FIG. 6 illustrates another flyback converter circuit for AC-DC conversion. As shown in FIG. 6, the LED driving device may be incorporated in the flyback convener circuit. Similar to FIG. 2, the flyback converter circuit may include a power supply circuit, a chopper circuit, and an LED load. The power supply circuit may include an AC power supply, a fuse F, capacitors C1 and C2, inductance L1, and a bridge rectifier D′. The chopper circuit may include resistors R1 , R2, R3, R4, R5, R6. R7, R8, and R9, capacitors C3, C4, C5, and C9, a transformer, diode D1, the LED driving device, and two DC-DC converters. The LED load may include a plurality of LEDs, e.g., LED1-LED4 as shown in FIG. 6.

As described above, the disclosed LED driving device may be used in the step-down BUCK-chopper circuit shown in FIG. 2, the bidirectional BUCK BOOST-chopper circuit shown in FIG. 3, the step-up BOOST-chopper circuit shown in FIG. 4, and the flyback convener circuits shown in FIGS. 5 and 6. The disclosed LED driving device may also be used in SEPIC circuits, FORWARD circuits, and HALFBRIDGE circuits. The LED driving device used in the abovementioned circuits may include the disclosed control unit and the power unit. The arrangement and specific types of the control unit and the power unit may be adjusted according to different applications and/or designs, and is not limited by the embodiments of the present disclosure.

in summary, the disclosed LED driving device may be used in step-down BUCK-chopper circuits, bidirectional BUCK BOOST-chopper circuits, step-up BOOST-chopper circuits, flyback convener circuits, SEPIC circuits, FORWARD circuits, HALFBRIDGE circuits, and other suitable circuits. A GaN MOSFET wafer may be used as the power unit of the disclosed LED driving device. When the LED driving device is operating at high speed, the disclosed LED driving device may have less interference, less wear and tear, and higher switching speed compared to a conventional silicon high-voltage MOSFET. Because the power unit is integrated into the LED driving device, components and parts arranged neighboring the GaN MOSFET wafer, e.g., inductances, transformers, and capacitors, may have shorter connection lines to the power unit. The LED driving device may have reduced dimensions. High frequency issues caused by long connection lines, such as parasitic inductances and interference, may be reduced, and high frequency performance of the LED driving device may be improved. In addition, the power unit, made of GaN MOSFET wafer, and the control unit may be configured to collaborate so that high-frequency switching signals generated by the control unit may be optimized. The integrated packaging may enable the control loop to have a reduced area. Parasitic inductances may be reduced.

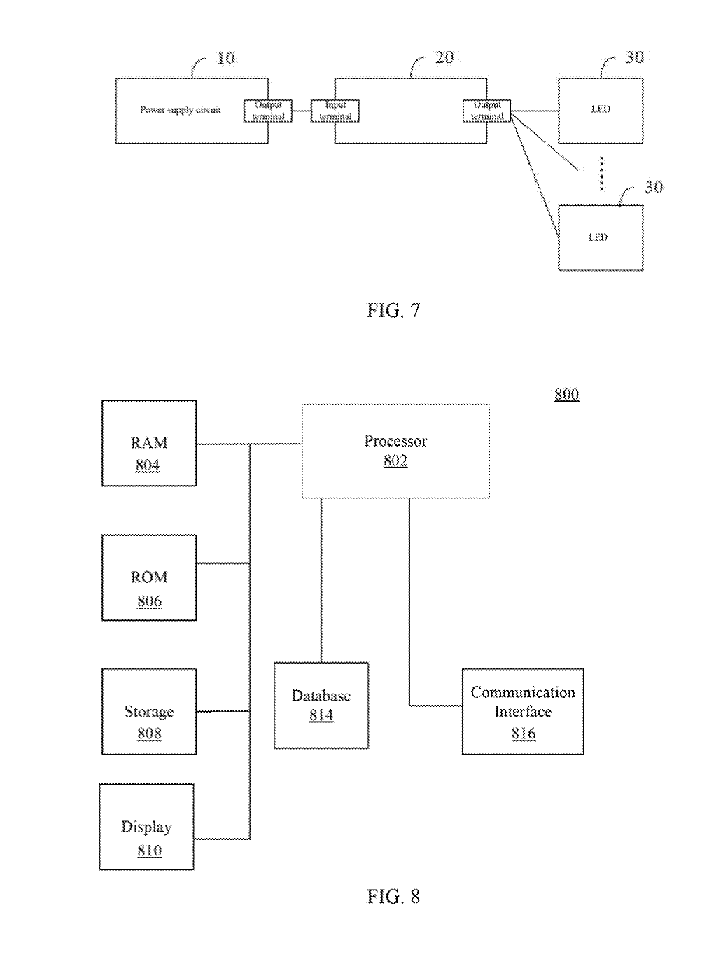

FIG. 7 illustrates the structure of a disclosed LED lighting device. As shown in FIG. 7, the LED lighting device may include a power supply circuit 10, a driving circuit 20, and at least one LEDs 30. The output terminal of the power supply circuit 10 may be connected to the input terminal of the driving circuit 20. The output terminal of the driving circuit 20 may be connected to at least one LED 30.

FIG. 8 is the block diagram of an exemplary control unit 800 used in the embodiments of the present disclosure. The control unit 800 corresponds to the control unit 11 described in FIG. 1.

The control unit 800 receive, process, and execute commands from the LED driving device. The control unit 800 may include any appropriately configured computer system. As shown in FIG. 8, control unit. 800 may include a processor $02. a random, access memory (RAM) 804, a read-only memory (ROM) 806, a storage 808, a display 810, an input/output interface 812, a database 814; and a communication interface 816. Other components may be added and certain devices may be removed without departing from the principles of the disclosed embodiments.

Processor 102 may include any appropriate type of general purpose microprocessor, digital signal processor or microcontroller, and application specific integrated circuit (ASIC). Processor 802 may execute sequences of computer program instructions to perform various processes associated with control unit 800. Computer program instructions may be loaded into RAM 804 for execution by processor 802 from read-only memory 806, or from storage 808. Storage 808 may include any appropriate type of mass storage provided to store any type of information that processor 802 may need to perform the processes. For example, storage 808 may include one or more hard disk devices, optical disk devices, flash disks, or other storage devices to provide storage space.

In some embodiments, display 810 may provide on of the control unit 800. Display 810 may include any appropriate type of computer display device or electronic device display, such as a small LCD display panel (e.g., CRT or LCD based devices). Further, database 814 may include any type of commercial or customized database, and may also include analysis tools for analyzing the information in the databases. Database 814 may be used for storing information for semiconductor manufacturing and other related information. Communication interface 816 may provide communication connections such that control, unit 800 may be accessed remotely and/or communicate with other systems through direct connections, computer networks or other communication networks via various communication protocols, such as transmission control protocol/internet protocol (TCP/IP), hyper text transfer protocol (HTTP), etc.

In one embodiment, the processor 802 may receive, process, and execute the commands to obtain data from the power unit. The communication interface can communicate with the power unit to collect and process data from the power unit. Suitable data may be stored in ROM 806 and storage 808 to be processed. After the data is processed, a suitable working frequency may be generated by the power unit. Optionally, the working frequency can be returned to the user via the display 810 or the input/output interlace 812.

In the disclosed LED lighting device, a GaN MOSFET wafer may be used as the power unit. The GaN MOSFET wafer may be incorporated into the LED lighting device to form an IC. When operating at a high speed, the disclosed LED lighting device may have improved resistance to interference, less wear and tear, and higher switching speed compared to a conventional high-voltage silicon MOSFET. Meanwhile, the volumes of the neighboring components, e.g., inductances, transformers, and capacitors, and the connections lines between the components may be reduced. Thus, high frequency issues caused by long connection lines may be reduced. The integrated packaging may enable the control loop to have a reduced foot print. Parasitic inductances may be reduced. In addition, the power unit and the control unit may be configured to collaborate so that high-frequency switching signals generated by the control unit may be optimized.

It should be, noted that, a GaN MOSFET wafer is used to described the disclosure. In various other embodiments, other suitable MOSFET wafers with improved high-frequency performance may also be incorporated into an IC that can be used in the circuits described above to convert AC current to DC current for the operation of the LED load. The specific types of the MOSFET wafer, and the arrangement of the control unit and the power unit in the IC should be determined according to different applications and designs and should not be limited by the embodiments of the present disclosure.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

In the present disclosure, GaN MOSFET wafer may be used as the power unit in the LED driving device. When the LED driving device is operating at a high speed, the disclosed LED driving device may have less interference, less wear and tear, and higher switching speed compared to a conventional silicon high-voltage MOSFET. Because the power unit is integrated into the LED driving device, components and parts arranged neighboring the GaN MOSFET wafer, e.g., inductances, transformers, and capacitors, may have shorter connection lines and reduced dimensions. High frequency issues caused by long connection lines such as parasitic inductances and interference may be reduced, and high frequency performance of the LED driving device may be improved. In addition, the power unit, e.g., made of GaN MOSFET wafer, and the control unit may be configured to collaborate so that high-frequency switching signals generated by the control unit may be optimized. The integrated packaging may enable the control loop to have a reduced area. Parasitic inductances may be reduced.

### REFERENCE SIGN LIST

Control unit 11 and 800

Power unit 12

Packaging substrate 13

Electrical contact points 14

Pin 15

Packaging material 16

Power supply circuit 10

Driving circuit 20

At least one LED 30

Processor 802

RAM 804

ROM 806

Storage 808

Display 810

Database 814

Communication interface 816

1-6. (canceled)

7. A light-emitting diode (LED) driving device, comprising a control unit and, a power unit integrated on a packaging substrate to form, an integrated circuit (IC), the control unit being electrically connected to the power unit for controlling the power unit to convert an AC current to a DC current for an LED load to emit light, wherein the control unit is configured to generate a control signal with a lowest working frequency higher than 250 KHz.

7. The LED driving device according to claim 7, wherein:
the power unit includes a GaN metal oxide semiconductor field effect transistor (MOSFET) wafer.

8. The LED driving device according to claim 7, further comprising a packaging substrate, wherein:
the control unit and the power unit are fixed on the packaging substrate;
electrical contact points of the control unit and the power unit for connecting external components are each connected to a pin of the packaging substrate; and
a bonding material is used to package the control unit and the power unit on the packaging substrate.

10. The LED driving device according to claim 7, wherein the electrical contact points include a gate electrode, a source electrode, and a drain electrode of the power unit, the gate electrode of the power unit being connected to an output terminal of the control unit, the source electrode of the power unit being grounded, and the drain electrode of the power unit being connected to an anode of the LED load.

11. The LED driving device according to claim 7, wherein the LED driving device is incorporated in one or more of a step-down BUCK-chopper circuit, bidirectional BUCK BOOST-chopper circuit, a step-up BOOST-chopper circuit, a flyback converter circuit, a SEPIC circuit, a FORWARD circuit, and a HALEBRIDGE circuit.

12. A light-emitting diode (LED) lighting device, comprising: a power supply circuit, a driving circuit, and at least one LED, the power supply circuit being connected to an input terminal of the driving circuit, an output terminal of the driving circuit being connected to the at least one LED, wherein the driving circuit includes at least one LED driving device according to claim 7.
